(19) United States
(12) Patent Application Publication
(10) Pub. No.: US 2019/0164057 A1
(43) Pub. Date: May 30, 2019

(54) MAPPING AND QUANTIFICATION OF INFLUENCE OF NEURAL NETWORK FEATURES FOR EXPLAINABLE ARTIFICIAL INTELLIGENCE

(71) Applicant: Intel Corporation, Santa Clara, CA (US)

(72) Inventor: KSHITIJ DOSHI, Tempe, AZ (US)

(73) Assignee: Intel Corporation, Santa Clara, CA (US)

(21) Appl. No.: 16/262,010

(22) Filed: Jan. 30, 2019

(51) Int. Cl. G06N 3/08; G06N 3/04

(52) U.S. Cl. CPC G06N 3/084; G06N 3/04

(57) ABSTRACT

Embodiments are directed to mapping and quantification of neural network features for explainable artificial intelligence. An embodiment of one or more storage mediums includes instructions for evaluating contribution of lower level features to higher level features in a neural network, the evaluation including one or more of identification of links between lower level and higher level features, and quantification of contribution of lower level features to higher level features. An embodiment of one or more storage mediums includes instructions for determining support from one or more features for one or more inference decisions by a neural network; determining strength of support for each of the inference decisions; identifying one or more inference decisions with low stability based at least in part on the determined strength of support; and reevaluating the inference decisions that are identified as having low stability.

### TECHNICAL FIELD

Embodiments described herein generally relate to the field of computing systems and, more particularly, mapping and quantification of neural network features for explainable artificial intelligence.

### BACKGROUND

A deep neural network (DNN), as applied artificial intelligence (AI) operation, is an artificial neural network that includes multiple neural network layers. Broadly speaking, neural networks operate to spot patterns in data, and provide decisions based on such patterns.

However, neural network models are extremely opaque. This is a significant hurdle to their broader use. This may have significant impact in implementations that require the ability to parse and justify decisions that are produced by such models, particularly where the decisions have ethical, legal, medical and physical safety ramifications.

Opaqueness of neural model models is also a significant barrier to detecting when such models are in error, and understanding the source of the errors. This can greatly inhibit the ability to impose corrective actions. Further, opaqueness inhibits the generalization and transferability of models, and thus makes it difficult to know when to proceed confidently based on their outputs.

### BRIEF DESCRIPTION OF THE DRAWINGS

Embodiments described here are illustrated by way of example, and not by way of limitation, in the figures of the accompanying drawings in which like reference numerals refer to similar elements.

FIG. 1 is an illustration of mapping and quantization of features in a neural network according to some embodiments;

FIG. 2A is an illustration of identification of links between lower level and higher level features in a neural network according to some embodiments;

FIG. 2B is an illustration of training of a neural network to provide capability to identify links between lower and higher level features according to some embodiments;

FIG. 3 is an illustration of quantification of key lower level features to key higher level features in a neural network according to some embodiments;

FIG. 4A is an illustration of neural network training to produce values related to generating inference classifications according to some embodiments;

FIG. 4B is an illustration of secondary neural network training to produce values related to changing inference classifications according to some embodiments;

FIG. 5A is an illustration of assessment of stability of support for inference by a neural network according to some embodiments;

FIG. 5B is an illustration of reevaluation of weaker decisions of neural networks according to some embodiments;

FIG. 6 is an illustration of an apparatus or system to provide mapping and quantification of neural network features for explainable artificial intelligence according to some embodiments;

FIG. 7 illustrates mapping and quantification of neural network features for explainable artificial intelligence in a processing system according to some embodiments;

FIG. 8 illustrates a computing device according to some embodiments;

FIG. 9 is a generalized diagram of a machine learning software stack; and

FIGS. 10A-10B illustrate an exemplary convolutional neural network.

### DETAILED DESCRIPTION

Embodiments described herein are directed to mapping and quantification of neural network features for explainable artificial intelligence.

Explainability of neural networks can include multiple aspects, including the degree to which a model is confident in its decisions; and, when confident, identification of the trace for that confidence from inputs, to various intermediate stages of processing, to the output. This type of analysis has numerous benefits, including that decisions of neural networks, even if such decisions are not transparent in total, may become transparent in parts by such analysis, particularly if the model is designed to capture confidence in human understandable terms in the determination of intermediate decisions or features. This is particularly useful in artificial intelligence applications in which higher levels of risk need to be mitigated.

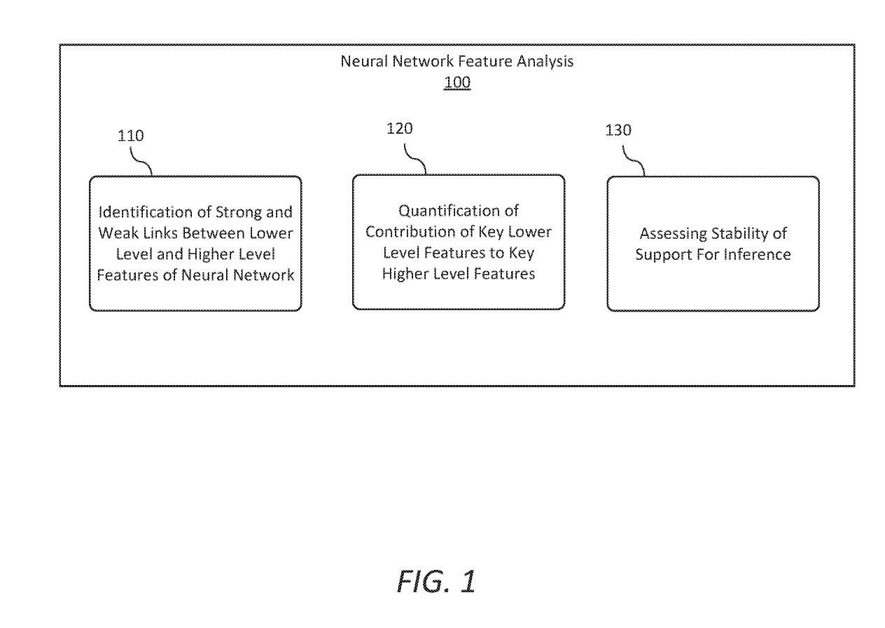

FIG. 1 is an illustration of mapping and quantization of features in a neural network according to some embodiments. In some embodiments, an apparatus, system, or process for neural network feature analysis 100 provides for one or more of the following:

(1) Identification of Strong and Weak Links Between Lower Level And Higher Level Features of Neural Network 110—In some embodiments, qualitative relationships are established between lower and higher level features in a neural network model by looking backwards from outputs through intermediate layers to inputs in the model to identify, for each higher level feature present in an outer layer, any lower level features in earlier layers that contribute to the presence of that higher level feature. Higher layer features are expressed statistically in terms of lower level features when this is possible. Given the highly non-convex nature of relationships, it is not expected that such contribution will be established in every case, but, for neural networks layers that are not too far apart, the relationship between lower and higher level features can be expected to hold in the sense that a complex decision can often be made understandable in stages.

(2) Quantification of Contribution of Key Lower Level Features to Key Higher Level Features 120—In some embodiments, upon determining that a qualitative relationship is established between lower and higher level features for a model, a quantitative relationship between lower and higher level features is established, and the dominant contributors in that quantitative relationship are identified.

(3) Assessing Stability of Support for Inference 130—In some embodiments, the presence of strong and weak relationships in each given inference decision are evaluated, and then it is determined whether a classification or decision in an outer layer is supported by a few strong factors or many weak factors. These determination(s) are based on the concept that many factors, even if they are individually weak, are indicative of greater stability of inference because the result is more resilient to errors in a few factors.

### Identification of Strong and Weak Links Between Lower Level and Higher Level Features of Neural Network

In some embodiments, an apparatus, system, or process provides for identification of which lower level features in a neural network have a strong or weak link to higher level features of the neural network. In some embodiments, model training for a neural network includes building in capabilities that allow identification of various lower level features that have a high level of influence over those higher level features that either positively or negatively affect the inference to a high degree, wherein, as used herein, a high level of influence (or a relatively higher level of influence) means that a value of a lower level feature has a high impact or effect (or relatively greater impact or effect) on a value of a higher level feature, and a low level of influence (or a relatively higher level of influence) means a value of a lower level feature has a low impact or effect (or relatively less impact or effect) on a value of a higher level feature.

In some embodiments, an apparatus, system, or process is to adjust one or more weights of one or more levels of a neural network based on an evaluation of contribution of lower level features to higher level features in the neural network.

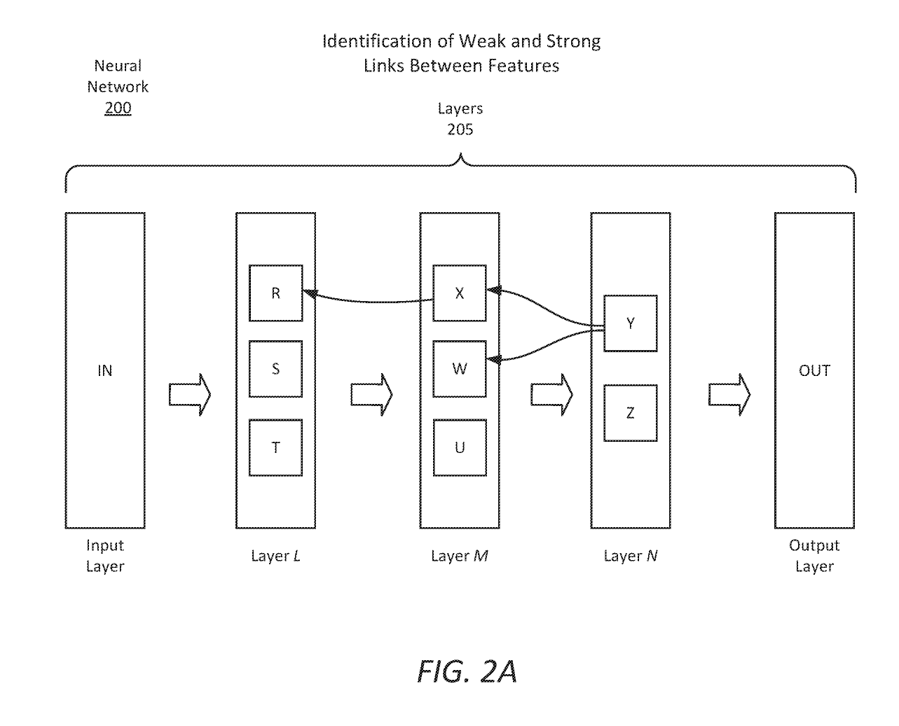

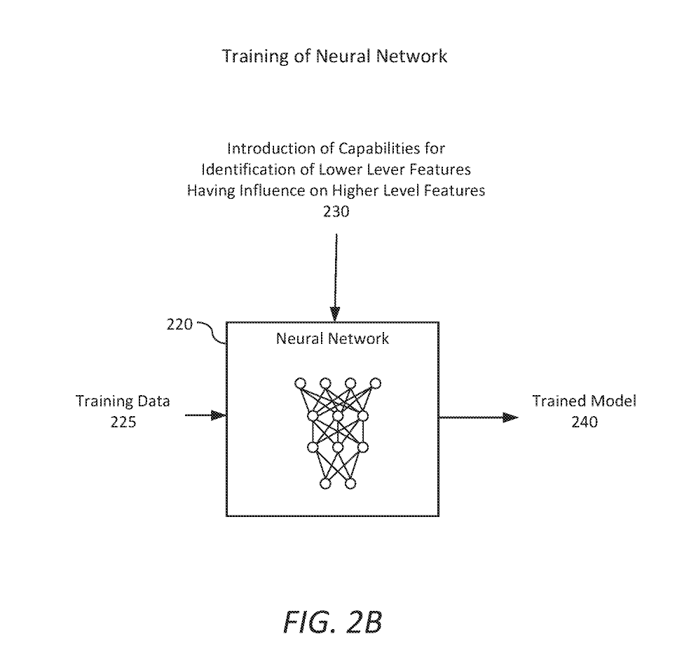

FIG. 2A is an illustration of identification of links between lower level and higher level features in a neural network according to some embodiments. As illustrated in FIG. 2A, a neural network model 200 includes multiple layers 205, wherein the operation of the layers 205 in inference is generally opaque to a user in a conventional apparatus or system. The layers 205 include an input layer, shown to the left in the illustration, and an output layer, shown to the right in the illustration. Between the input layer and the output layer are any number of intermediate layers, shown in FIG. 2A as layers L, M, and N. While for ease of illustration no other layers are shown, and the intermediate layers are shown together, there may be any number of other layers that exist between the illustrated layers.

In some embodiments, an operation or technique for identification of links between lower level and higher level features of the neural network, performed by an apparatus, system, or process, involves looking or examining backwards through the layers 205 in the neural network model 200. As illustrated in FIG. 2A, the model layers are arranged left to right from input to output. In some embodiments, the apparatus, system, or process is to look leftward from each feature in a particular layer, such as feature Y in a given layer N, towards some layer M to the left (closer to the input) of N. In doing so, the apparatus, system, or process is building into the neural network 200 the capability to identify one or more features such as X (in layer M) whose influence on Y (in layer N) is greater than (i.e., a value of X has the highest relative level of impact or effect on a value of Y) that from other features in M (such as features W and U); and then, identifying some other feature W in M whose influence on Y, while less than that of X, is greater than that of other features in (M—X); and so on. Having determined this, the next stage of analysis relates a given feature X in layer M, similarly to features in some other layer L further to the left of layer M, and so on. This type of information mapping may be accomplished by a technique such as measuring mutual information (as opposed to a correlation coefficient), by empirically measuring the ratio of joint to marginal probability distributions of p(X, Y)/p(X)p(Y) between each pair {X, Y} of lower and higher level features.

In some embodiments, other, more complex techniques may be employed, for example, to measure dependences between each higher-level feature and multiple lower-level features; or by measuring which variable in a lower feature level has the least amount of effect on a given higher-level feature, iteratively, etc.

Such mutual information ranking across successive layers of features is akin to understanding a complex relationship chain between input and output in terms of constituent relationships. When humans wish to explain something complicated, they commonly break the subject up into stages, with each stage of explanation making the next level of complexity more accessible. In some embodiments, an apparatus, system, or process is to build up the matrix of mutual information between features in earlier layers (left) to features in later layers (to their right), and, similarly the information between features in those later layers and features in layers further to their right, and so on.

FIG. 2B is an illustration of training of a neural network to provide capability to identify links between lower and higher level features according to some embodiments. In some embodiments, a neural network 220 is trained such that at inference time the neural network produces not only the decisions from the inference, but also produce identification of the important earlier features leading up to those decisions. As illustrated in FIG. 2B, the training of the neural network 220 includes the introduction of training data 225, with the training process resulting in a trained model 240 to provide inference operation. In some embodiments, the training of the neural network 220 includes the introduction of capabilities for identification of lower level features that have influence on higher level features, such as the features illustrated in FIG. 2A.

It is noted that it may be found that the relationships between lower level and higher level features are irregular in the sense that, given the presence of some lower level factor G, another lower level important factor F may be bypassed in reaching a decision about a higher level feature H. The apparatus, system, or process thus can provide an explanation as to why, for example, the model produces a decision in one circumstance, recorded as being driven by presence of factor F, but it may produce an opposite decision in a second circumstance in which factor F was present, but so was the factor G.

Thus, by assessing how strong the links are between antecedent features in earlier layers and subsequent features in later layers, the ability to explain the neural network operation is further built upon or improved. In a specific real-world example, the weight of evidence in favor of high inflation might be high employment in a first case, or it may be greater deficit in government budget in a second case, or it may be high liquidity in a third case. Each of these factors is in itself a result of statistical inferences from other measurements such as local inflation in different geographic area, local unemployment figures, correlated with rates of increase or decrease, etc.

### Quantification of Contribution of Key Lower Level Features to Key Higher Level Features

In some embodiments, an apparatus, system, or process provides for establishing a quantitative relationship among the significant factors/features in a previous layer M of a neural network in determining a factor/feature in a later layer N, where layer M and layer N may be layers as illustrated in FIG. 2A. This quantitative assessment helps further sharpen explanations for any given higher level feature by identifying the combinations of features that contribute to a greater degree in a given classification. In some embodiments, an apparatus, system, or process is to perform a principal component analysis among the categories of important features in a particular layer M, to yield the key eigenvectors (and resulting eigenvalues) identification of links between lower level and higher level features in a neural network according to some embodiments, while excluding less salient features in layer M that have less influence in the generation of a result.

In some embodiments, an apparatus, system, or process is to adjust one or more weights of one or more levels of a neural network based on an evaluation of contribution of lower level features to higher level features in the neural network.

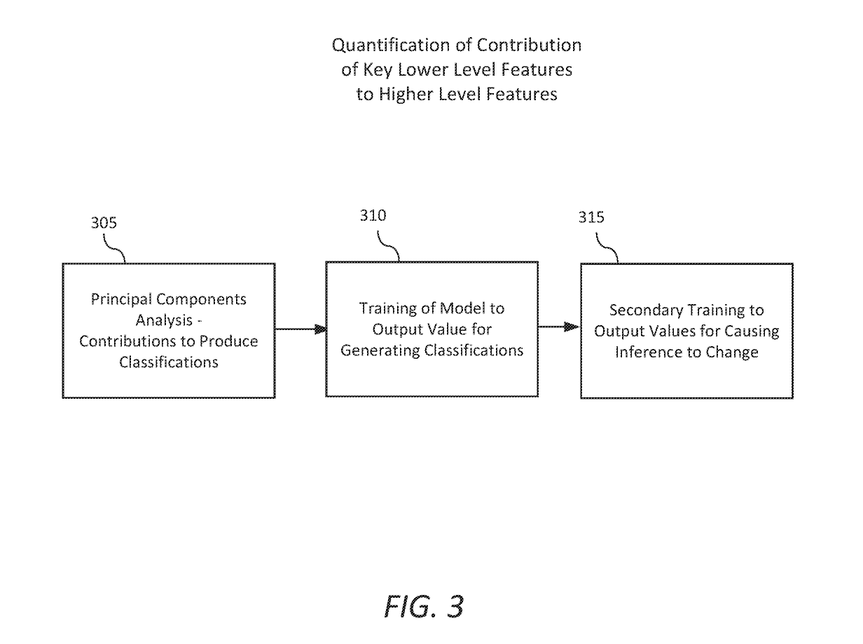

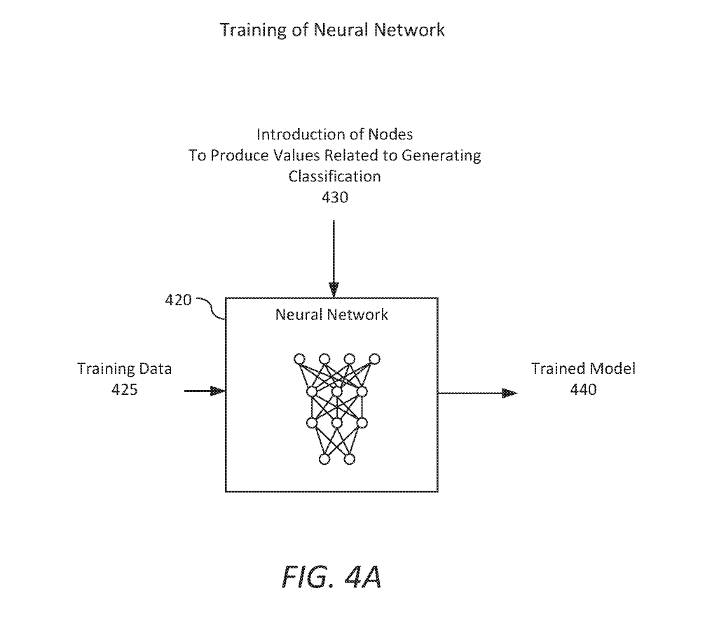

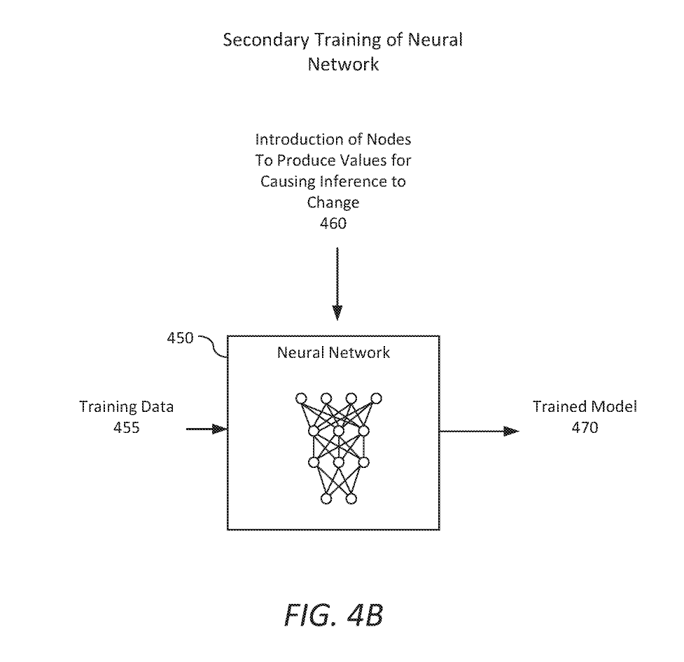

FIG. 3 is an illustration of quantification of key lower level features to key higher level features in a neural network according to some embodiments. In some embodiments, during training of a neural network model, an apparatus, system, or process is to perform Principal Components Analysis (PCA) 305 that identifies the weight, or contribution, of different combinations of underlying features (i.e., the eigenvector(s) that is/are being evaluated) that produce various classifications. In some embodiments, the process further includes neural network training 310 for introducing into the model additional nodes (also referred to as neurons) in the neural network during training to produce the values producing classifications, i.e., the eigenvalues for the relevant eigenvectors. The neural network training 310 is further illustrated in FIG. 4A.

In this way, the apparatus, system, or process is to essentially embed the PCA over the feature vectors into the trained model itself. Then at run time (inference time) or during incremental learning, the trained neural network is structured to output not only the classification, but also the reason or cause for the classification, the reason or cause being provided in the form of the output eigenvalues. These values then may be utilized to serve as a proxy for human or machine understandable explanations for those classifications. This leads to potentially layering features into hierarchies and producing explanations for what contributed to a specific decision.

In some embodiments, optional secondary neural network training 315 may be performed to quantify the inverse of the above, i.e., deciding which features when removed (de-activated) from a given input-to-inference produce greatest likelihood of causing the inference to change to a substantially different output value (i.e., more than a nominal change in output value), which may also be referred to as flipping the inference. This leads to identifying the most distinctive inner layer characteristic that constitutes, or supports, a given feature in an outer layer. The secondary neural network training 315 is further illustrated in FIG. 4B.

FIG. 4A is an illustration of neural network training to produce values related to generating inference classifications according to some embodiments. As illustrated in FIG. 4A, training of a neural network 420 includes training data 425 being input to the neural network 420, and further includes introduction of nodes 430 to produce values (eigenvalues) related to output classifications (eigenvectors) during inference. In some embodiments, the training is to result in a trained model 440 including the introduced nodes for eigenvalue production.

FIG. 4B is an illustration of secondary neural network training to produce values related to changing inference classifications according to some embodiments. As illustrated in FIG. 4B, secondary training of a neural network 450 (which may include the trained model 440 generated in FIG. 4A) includes training data 455 being input to the neural network 450, and further includes introduction of nodes 460 to produce values (eigenvalues) related to the changing of classifications during inference. In some embodiments, the training is to result in a trained model 470 including the introduced nodes for eigenvalue production.

### Assessing Stability of Support for Inference

In some embodiments, an apparatus, system, or process is to assess the stability of support of a neural network for inference. In some embodiments, a determination is made regarding whether a classification or decision in an outer layer is supported upon a few strong factors or many less strong factors. The concept to be applied is that when a decision is based upon numerous factors the decision tends to be more robust against weakness of individual factors. This is because a large amount of corroborating evidence increases confidence in the decision. Further, when evidence against a conclusion is not sufficiently strong, but there are enough factors weighing in its favor, this argues for revisiting and reevaluating the decision. In some embodiments, such reevaluation of a decision may be performed with (a) limited perturbation over the input or (b) by application of a more compute intensive model as a backup, to establish better support for the decision, which in turn assists in providing a better explanation regarding the decision generated in the inference process.

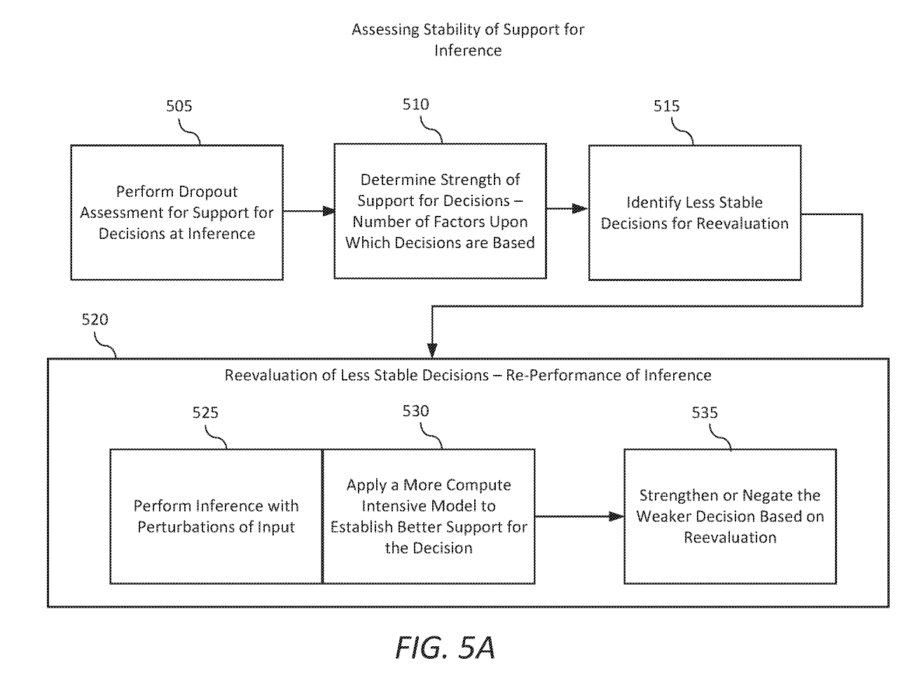

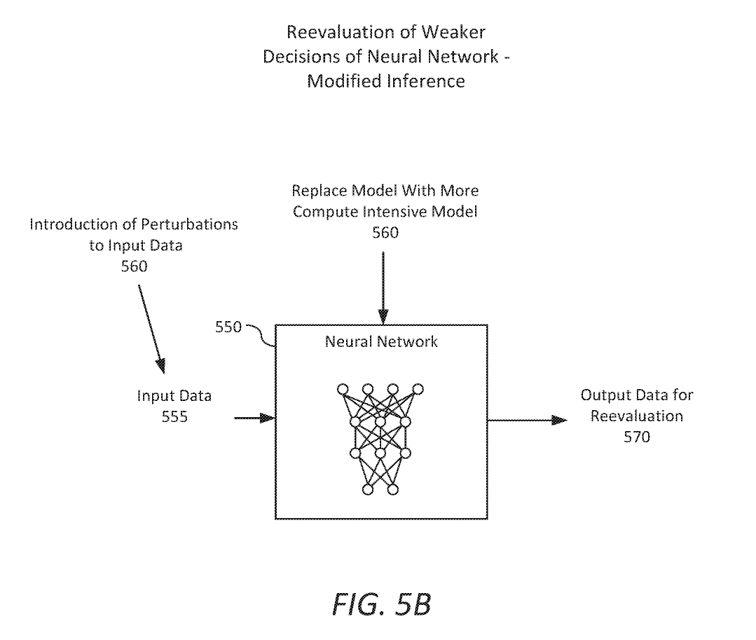

FIG. 5A is an illustration of assessment of stability of support for inference by a neural network according to some embodiments. In some embodiments, an apparatus, system, or process is to determine support from one or more features associated with a plurality of layers of a neural network, wherein determining support may include performing an operation related to training with dropouts, which is an approach that is intended to avoid overfitting a model to training data and refers herein to an assessment in which one or more factors are removed to determine support for one or more decisions of the model. Stated in another way, a dropout assessment includes removal of one or more factors to determine what effect there is on a decision of the model. Dropout assessment may be performed at inference time, to assess strength of support among contributing factors. Weaker or less confident decisions can then be reevaluated and strengthened, or negated, by using ensemble methods. As an alternative to ensemble decisions, weights in various layers, particularly where the decisions are found to be resting on few factors, may be drawn from distributions centered on their point values. Similarly, inputs may be perturbed with addition of limited variation, in combination with or separately from inference time dropout assessment, to test stability of decisions.

In some embodiments, as illustrated in FIG. 5A, a dropout assessment is performed for support for decisions at inference 505. The assessment includes the removal of one or more factors to identify which factors provide support for a decision. A determination is made regarding the strength of support for decisions in terms of the number of factors upon which decisions are made 510. Decisions that are based on numerous factors may be identified as more stable, and decisions that are based on few factors (such as a number of factors that is less than or equal to a certain threshold) may be identified as less stable (or having low stability). In this manner, less stable or robust decisions from inference are identified or tagged as such 515.

In some embodiments, one or more inference decisions that are identified as being less stable are reevaluated, wherein the reevaluation of such less stable decisions includes re-performance of inference 520. In some embodiments, the re-performance of the inference includes a modification of the inference in manner designed to either strengthen or negate the inference decision.

In some embodiments, the re-performance of inference includes sampling from the input space with certain small perturbations or noise in the input data 525. In this manner, an apparatus, system or process may detect whether the decisions remain stable when the input is subjected to noise, or, stated in another way, when the quality of the evidence the decisions rest on is reduced.

In some embodiments, the re-performance of inference additionally or as a substitute includes applying a more compute intensive model of the neural network to establish better support for a decision 530. For example, the training of the neural network may include the generation of model that is more compute intensive (e.g., using higher precision, greater amount of Monte Carlo sampling over statistically sampled neural network parameters, and so on), and thus less efficient in operation, as a backup model, and this backup model may be selected for use in reevaluation of decisions.

FIG. 5B is an illustration of reevaluation of weaker decisions of neural networks according to some embodiments. As illustrated in FIG. 5B, upon identifying a decision as being a weaker decision, i.e., a decision identified as being less stable because the decision is based on a small number of factors, decision may be reevaluated. In the reevaluation, inference by the neural network 550 is re-performed, wherein the inference is modified in a manner designed to either strengthen the inference decision or negate the inference decision. As shown, the inference process includes the introduction input data 555 to the neural network 550 to generate output data for reevaluation of the output data (decision) 570.

In some embodiments, the modified inference process includes the introduction of perturbations or noise 560 into the input data 555, wherein an apparatus, system, or process may detect whether, based on the output data 570, a decision remains unchanged with lower quality (noisier) input data.

In some embodiments, the modified inference additionally or as a substitute includes replacing the neural network model with a more compute intensive model of the neural network to establish better support for a decision 530, wherein an apparatus, system, or process may detect whether, based on the output data 570, a decision remains unchanged with greater computation in the inference process.

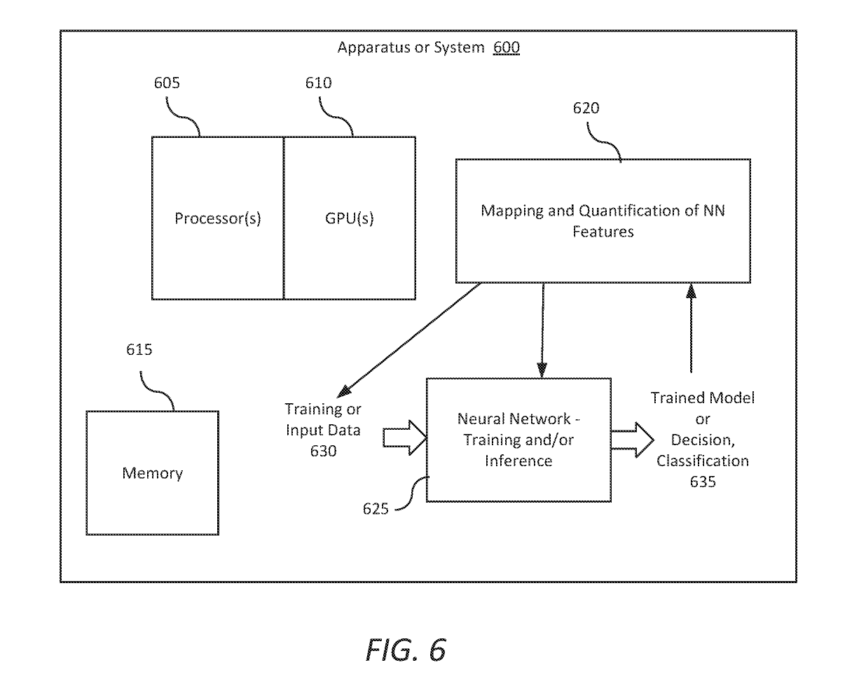

FIG. 6 is an illustration of an apparatus or system to provide mapping and quantification of neural network features for explainable artificial intelligence according to some embodiments. As shown in FIG. 6, an apparatus or system 600 includes one or more processors 605, which may for example include one or more CPUs (Central Processing Units) (which may operate as a host processor), having one or more processor cores, and one or more graphics processing units (GPUs) 610 having one or more graphics processor cores, wherein the GPUs may be included within or separate from the one or more processors 605. GPUs may include, but are not limited to, general purposed graphics processing units (GPGPUs). The apparatus or system 600 further includes a memory 615 (a computer memory) for the storage for data, including neural network processing. The memory 615 may include, but is not limited to, dynamic random access memory (DRAM).

In some embodiments, the apparatus or system 600 includes elements or circuits for mapping and quantification of neural network features 620. In some embodiments, the mapping and quantification of neural network features includes one or more of identification of strong and weak links between lower level and higher level features of neural network 110, quantification of contribution of key lower level features to key higher level features 120, or assessing stability of support for inference 130, as illustrated in FIG. 1 and as further illustrated and explained in FIG. 2 through FIG. 5B. In some embodiments, the mapping and quantification of neural network features operations in the training and/or inference of a neural network 625, including modification of training or input data 630, modification or substitution of the neural network model 625, and evaluation of the trained model output in training or the decisions or classifications output in inference 635.

### System Overview

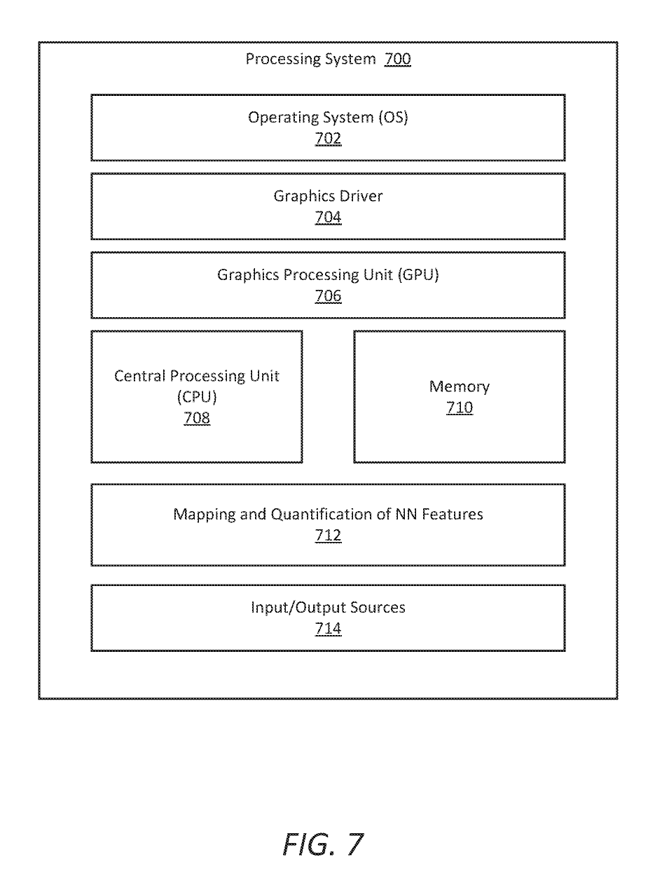

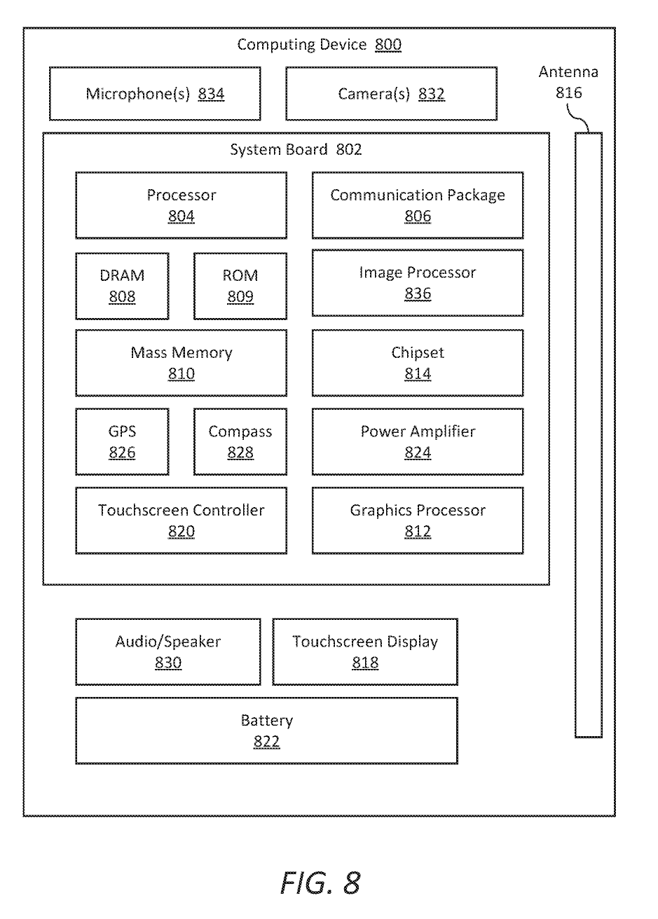

FIG. 7 illustrates mapping and quantification of neural network features for explainable artificial intelligence in a processing system according to some embodiments. For example, in one embodiment, an element or mechanism for mapping and quantification of neural network features 712 of FIG. 7 may be employed or hosted by a processing system 700, which may include, for example, computing device 800 of FIG. 8. Processing system 700 represents a communication and data processing device including or representing any number and type of smart devices, such as (without limitation) smart command devices or intelligent personal assistants, home/office automation system, home appliances (e.g., security systems, washing machines, television sets, etc.), mobile devices (e.g., smartphones, tablet computers, etc.), gaming devices, handheld devices, wearable devices (e.g., smartwatches, smart bracelets, etc.), virtual reality (VR) devices, head-mounted display (HMDs), Internet of Things (IoT) devices, laptop computers, desktop computers, server computers, set-top boxes (e.g., Internet based cable television set-top boxes, etc.), global positioning system (GPS)-based devices, etc.

In some embodiments, processing system 700 may include (without limitation) autonomous machines or artificially intelligent agents, such as a mechanical agents or machines, electronics agents or machines, virtual agents or machines, electro-mechanical agents or machines, etc. Examples of autonomous machines or artificially intelligent agents may include (without limitation) robots, autonomous vehicles (e.g., self-driving cars, self-flying planes, self-sailing boats or ships, etc.), autonomous equipment (self-operating construction vehicles, self-operating medical equipment, etc.), and/or the like. Further, “autonomous vehicles” are not limited to automobiles but that they may include any number and type of autonomous machines, such as robots, autonomous equipment, household autonomous devices, and/or the like, and any one or more tasks or operations relating to such autonomous machines may be interchangeably referenced with autonomous driving.

Further, for example, processing system 700 may include a cloud computing platform consisting of a plurality of server computers, where each server computer employs or hosts a multifunction perceptron mechanism. For example, automatic ISP tuning may be performed using component, system, and architectural setups described earlier in this document. For example, some of the aforementioned types of devices may be used to implement a custom learned procedure, such as using field-programmable gate arrays (FPGAs), etc.

Further, for example, processing system 700 may include a computer platform hosting an integrated circuit (“IC”), such as a system on a chip (“SoC” or “SOC”), integrating various hardware and/or software components of processing system 700 on a single chip.

As illustrated, in one embodiment, processing system 700 may include any number and type of hardware and/or software components, such as (without limitation) graphics processing unit 706 (“GPU” or simply “graphics processor”), graphics driver 704 (also referred to as “GPU driver”, “graphics driver logic”, “driver logic”, user-mode driver (UMD), user-mode driver framework (UMDF), or simply “driver”), central processing unit 708 (“CPU” or simply “application processor”), memory 710 network devices, drivers, or the like, as well as input/output (TO) sources 714, such as touchscreens, touch panels, touch pads, virtual or regular keyboards, virtual or regular mice, ports, connectors, etc. Processing system 700 may include operating system (OS) 702 serving as an interface between hardware and/or physical resources of processing system 700 and a user.

It is to be appreciated that a lesser or more equipped system than the example described above may be preferred for certain implementations. Therefore, the configuration of processing system 700 may vary from implementation to implementation depending upon numerous factors, such as price constraints, performance requirements, technological improvements, or other circumstances.

Embodiments may be implemented as any or a combination of: one or more microchips or integrated circuits interconnected using a system board, hardwired logic, software stored by a memory device and executed by a microprocessor, firmware, an application specific integrated circuit (ASIC), and/or a field programmable gate array (FPGA). The terms “logic”, “module”, “component”, “engine”, and “mechanism” may include, by way of example, software or hardware and/or a combination thereof, such as firmware.

In one embodiment, mapping and quantification of neural network features 712 may be hosted by memory 710 of processing system 700. In another embodiment, mapping and quantification of neural network features 712 may be hosted by or be part of operating system 702 of processing system 700. In another embodiment, mapping and quantification of neural network features 712 may be hosted or facilitated by graphics driver 704. In yet another embodiment, mapping and quantification of neural network features 712 may be hosted by or part of graphics processing unit 706 (“GPU” or simply “graphics processor”) or firmware of graphics processor 706. For example, mapping and quantification of neural network features 712 may be embedded in or implemented as part of the processing hardware of graphics processor 706. Similarly, in yet another embodiment, mapping and quantification of neural network features 712 may be hosted by or part of central processing unit 708 (“CPU” or simply “application processor”). For example, mapping and quantification of neural network features 712 may be embedded in or implemented as part of the processing hardware of application processor 708.

In yet another embodiment, mapping and quantification of neural network features 712 may be hosted by or part of any number and type of components of processing system 700, such as a portion of mapping and quantification of neural network features 712 may be hosted by or part of operating system 702, another portion may be hosted by or part of graphics processor 706, another portion may be hosted by or part of application processor 708, while one or more portions of mapping and quantification of neural network features 712 may be hosted by or part of operating system 702 and/or any number and type of devices of processing system 700. It is contemplated that embodiments are not limited to certain implementation or hosting of mapping and quantification of neural network features 712 and that one or more portions or components of mapping and quantification of neural network features 712 may be employed or implemented as hardware, software, or any combination thereof, such as firmware.

Processing system 700 may host network interface(s) to provide access to a network, such as a LAN, a wide area network (WAN), a metropolitan area network (MAN), a personal area network (PAN), Bluetooth, a cloud network, a mobile network (e.g., 3rd Generation (3G), 4th Generation (4G), 5th Generation (5G), etc.), an intranet, the Internet, etc. Network interface(s) may include, for example, a wireless network interface having antenna, which may represent one or more antenna(e). Network interface(s) may also include, for example, a wired network interface to communicate with remote devices via network cable, which may be, for example, an Ethernet cable, a coaxial cable, a fiber optic cable, a serial cable, or a parallel cable.

Embodiments may be provided, for example, as a computer program product which may include one or more machine-readable media (including a non-transitory machine-readable or computer-readable storage medium) having stored thereon machine-executable instructions that, when executed by one or more machines such as a computer, network of computers, or other electronic devices, may result in the one or more machines carrying out operations in accordance with embodiments described herein. A machine-readable medium may include, but is not limited to, optical disks, CD-ROMs ROMs (Compact Disc-Read Only Memories), and magneto-optical disks, ROMs, RAMs, EPROMs (Erasable Programmable Read Only Memories), EEPROMs (Electrically Erasable Programmable Read Only Memories), magnetic tape, magnetic or optical cards, flash memory, or other type of media/machine-readable medium suitable for storing machine-executable instructions.

Moreover, embodiments may be downloaded as a computer program product, wherein the program may be transferred from a remote computer (e.g., a server) to a requesting computer (e.g., a client) by way of one or more data signals embodied in and/or modulated by a carrier wave or other propagation medium via a communication link (e.g., a modem and/or network connection).

Throughout the document, term “user” may be interchangeably referred to as “viewer”, “observer”, “speaker”, “person”, “individual”, “end-user”, and/or the like. It is to be noted that throughout this document, terms like “graphics domain” may be referenced interchangeably with “graphics processing unit”, “graphics processor”, or simply “GPU” and similarly, “CPU domain” or “host domain” may be referenced interchangeably with “computer processing unit”, “application processor”, or simply “CPU”.

It is to be noted that terms like “node”, “computing node”, “server”, “server device”, “cloud computer”, “cloud server”, “cloud server computer”, “machine”, “host machine”, “device”, “computing device”, “computer”, “computing system”, and the like, may be used interchangeably throughout this document. It is to be further noted that terms like “application”, “software application”, “program”, “software program”, “package”, “software package”, and the like, may be used interchangeably throughout this document. Also, terms like “job”, “input”, “request”, “message”, and the like, may be used interchangeably throughout this document.

FIG. 8 illustrates a computing device according to some embodiments. It is contemplated that details of computing device 800 may be the same as or similar to details of processing system 700 of FIG. 7 and thus for brevity, certain of the details discussed with reference to processing system 700 of FIG. 7 are not discussed or repeated hereafter. Computing device 800 houses a system board 802 (which may also be referred to as a motherboard, main circuit board, or other terms). The board 802 may include a number of components, including but not limited to a processor 804 and at least one communication package or chip 806. The communication package 806 is coupled to one or more antennas 816. The processor 804 is physically and electrically coupled to the board 802.

Depending on its applications, computing device 800 may include other components that may or may not be physically and electrically coupled to the board 802. These other components include, but are not limited to, volatile memory (e.g., DRAM) 808, nonvolatile memory (e.g., ROM) 809, flash memory (not shown), a graphics processor 812, a digital signal processor (not shown), a crypto processor (not shown), a chipset 814, an antenna 816, a display 818 such as a touchscreen display, a touchscreen controller 820, a battery 822, an audio codec (not shown), a video codec (not shown), a power amplifier 824, a global positioning system (GPS) device 826, a compass 828, an accelerometer (not shown), a gyroscope (not shown), a speaker or other audio element 830, one or more cameras 832, a microphone array 834, and a mass storage device (such as hard disk drive) 810, compact disk (CD) (not shown), digital versatile disk (DVD) (not shown), and so forth). These components may be connected to the system board 802, mounted to the system board, or combined with any of the other components.

The communication package 806 enables wireless and/or wired communications for the transfer of data to and from the computing device 800. The term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some embodiments they might not. The communication package 806 may implement any of a number of wireless or wired standards or protocols, including but not limited to Wi-Fi (IEEE 802.11 family), WiMAX (IEEE 802.16 family), IEEE 802.20, long term evolution (LTE), Ev-DO (Evolution Data Optimized), HSPA+, HSDPA+, HSUPA+, EDGE Enhanced Data rates for GSM evolution), GSM (Global System for Mobile communications), GPRS (General Package Radio Service), CDMA (Code Division Multiple Access), TDMA (Time Division Multiple Access), DECT (Digital Enhanced Cordless Telecommunications), Bluetooth, Ethernet derivatives thereof, as well as any other wireless and wired protocols that are designated as 3G, 4G, 5G, and beyond. The computing device 800 may include a plurality of communication packages 806. For instance, a first communication package 806 may be dedicated to shorter range wireless communications such as Wi-Fi and Bluetooth and a second communication package 806 may be dedicated to longer range wireless communications such as GSM, EDGE, GPRS, CDMA, WiMAX, LTE, Ev-DO, and others.

The cameras 832 including any depth sensors or proximity sensor are coupled to an optional image processor 836 to perform conversions, analysis, noise reduction, comparisons, depth or distance analysis, image understanding, and other processes as described herein. The processor 804 is coupled to the image processor to drive the process with interrupts, set parameters, and control operations of image processor and the cameras. Image processing may instead be performed in the processor 804, the graphics processor 812, the cameras 832, or in any other device.

In various implementations, the computing device 800 may be a laptop, a netbook, a notebook, an Ultrabook, a smartphone, a tablet, an ultra-mobile PC, a mobile phone, a desktop computer, a server, a set-top box, an entertainment control unit, a digital camera, a portable music player, or a digital video recorder. The computing device may be fixed, portable, or wearable. In further implementations, the computing device 800 may be any other electronic device that processes data or records data for processing elsewhere.

Embodiments may be implemented using one or more memory chips, controllers, CPUs (Central Processing Unit), microchips or integrated circuits interconnected using a motherboard, an application specific integrated circuit (ASIC), and/or a field programmable gate array (FPGA). The term “logic” may include, by way of example, software or hardware and/or combinations of software and hardware.

Machine Learning—Deep Learning

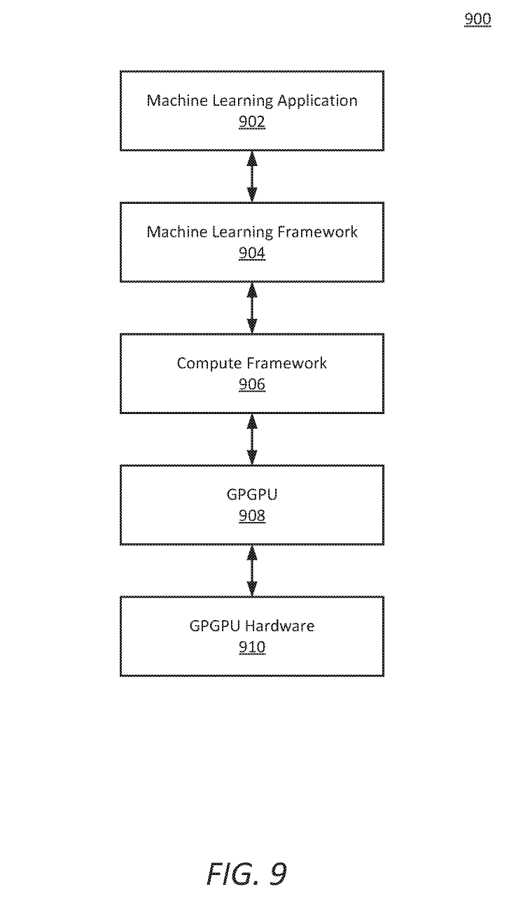

FIG. 9 is a generalized diagram of a machine learning software stack. FIG. 9 illustrates a software stack 900 for GPGPU operation. However, a machine learning software stack is not limited to this example, and may include, for also, a machine learning software stack for CPU operation.

A machine learning application 902 can be configured to train a neural network using a training dataset or to use a trained deep neural network to implement machine intelligence. The machine learning application 902 can include training and inference functionality for a neural network and/or specialized software that can be used to train a neural network before deployment. The machine learning application 902 can implement any type of machine intelligence including but not limited to image recognition, mapping and localization, autonomous navigation, speech synthesis, medical imaging, or language translation.

Hardware acceleration for the machine learning application 902 can be enabled via a machine learning framework 904. The machine learning framework 904 can provide a library of machine learning primitives. Machine learning primitives are basic operations that are commonly performed by machine learning algorithms. Without the machine learning framework 904, developers of machine learning algorithms would be required to create and optimize the main computational logic associated with the machine learning algorithm, then re-optimize the computational logic as new parallel processors are developed. Instead, the machine learning application can be configured to perform the necessary computations using the primitives provided by the machine learning framework 904. Exemplary primitives include tensor convolutions, activation functions, and pooling, which are computational operations that are performed while training a convolutional neural network (CNN). The machine learning framework 904 can also provide primitives to implement basic linear algebra subprograms performed by many machine-learning algorithms, such as matrix and vector operations. The machine learning framework 904 may further provide for statistical operations such as Markov Chain Monte Carlo processing in which inputs and neural network parameters may be sampled from statistical distributions centered around their point values, and training or inference outputs from individual forward passes are summarized (usually by empirical averaging operations) to produce statistically weighted outputs.

The machine learning framework 904 can process input data received from the machine learning application 902 and generate the appropriate input to a compute framework 906. The compute framework 906 can abstract the underlying instructions provided to the GPGPU driver 908 to enable the machine learning framework 904 to take advantage of hardware acceleration via the GPGPU hardware 910 without requiring the machine learning framework 904 to have intimate knowledge of the architecture of the GPGPU hardware 910. Additionally, the compute framework 906 can enable hardware acceleration for the machine learning framework 904 across a variety of types and generations of the GPGPU hardware 910.

### Machine Learning Neural Network Implementations

The computing architecture provided by embodiments described herein can be configured to perform the types of parallel processing that is particularly suited for training and deploying neural networks for machine learning. A neural network can be generalized as a network of functions having a graph relationship. As is known in the art, there are a variety of types of neural network implementations used in machine learning. One exemplary type of neural network is the feedforward network, as previously described.

A second exemplary type of neural network is the Convolutional Neural Network (CNN). A CNN is a specialized feedforward neural network for processing data having a known, grid-like topology, such as image data. Accordingly, CNNs are commonly used for compute vision and image recognition applications, but they also may be used for other types of pattern recognition such as speech and language processing. The nodes in the CNN input layer are organized into a set of “filters” (feature detectors inspired by the receptive fields found in the retina), and the output of each set of filters is propagated to nodes in successive layers of the network. The computations for a CNN include applying the convolution mathematical operation to each filter to produce the output of that filter. Convolution is a specialized kind of mathematical operation performed by two functions to produce a third function that is a modified version of one of the two original functions. In convolutional network terminology, the first function to the convolution can be referred to as the input, while the second function can be referred to as the convolution kernel. The output may be referred to as the feature map. For example, the input to a convolution layer can be a multidimensional array of data that defines the various color components of an input image. The convolution kernel can be a multidimensional array of parameters, where the parameters are adapted by the training process for the neural network.

Recurrent neural networks (RNNs) are a family of feedforward neural networks that include feedback connections between layers. RNNs enable modeling of sequential data by sharing parameter data across different parts of the neural network. The architecture for a RNN includes cycles. The cycles represent the influence of a present value of a variable on its own value at a future time, as at least a portion of the output data from the RNN is used as feedback for processing subsequent input in a sequence. This feature makes RNNs particularly useful for language processing due to the variable nature in which language data can be composed.

The figures described below present exemplary feedforward, CNN, and RNN networks, as well as describe a general process for respectively training and deploying each of those types of networks. It will be understood that these descriptions are exemplary and non-limiting as to any specific embodiment described herein and the concepts illustrated can be applied generally to deep neural networks and machine learning techniques in general.

The exemplary neural networks described above can be used to perform deep learning. Deep learning is machine learning using deep neural networks. The deep neural networks used in deep learning are artificial neural networks composed of multiple hidden layers, as opposed to shallow neural networks that include only a single hidden layer. Deeper neural networks are generally more computationally intensive to train. However, the additional hidden layers of the network enable multistep pattern recognition that results in reduced output error relative to shallow machine learning techniques.

Deep neural networks used in deep learning typically include a front-end network to perform feature recognition coupled to a back-end network which represents a mathematical model that can perform operations (e.g., object classification, speech recognition, etc.) based on the feature representation provided to the model. Deep learning enables machine learning to be performed without requiring hand crafted feature engineering to be performed for the model. Instead, deep neural networks can learn features based on statistical structure or correlation within the input data. The learned features can be provided to a mathematical model that can map detected features to an output. The mathematical model used by the network is generally specialized for the specific task to be performed, and different models will be used to perform different task.

Once the neural network is structured, a learning model can be applied to the network to train the network to perform specific tasks. The learning model describes how to adjust the weights within the model to reduce the output error of the network. Backpropagation of errors is a common method used to train neural networks. An input vector is presented to the network for processing. The output of the network is compared to the desired output using a loss function and an error value is calculated for each of the neurons in the output layer. The error values are then propagated backwards until each neuron has an associated error value which roughly represents its contribution to the original output. The network can then learn from those errors using an algorithm, such as the stochastic gradient descent algorithm, to update the weights of the of the neural network.

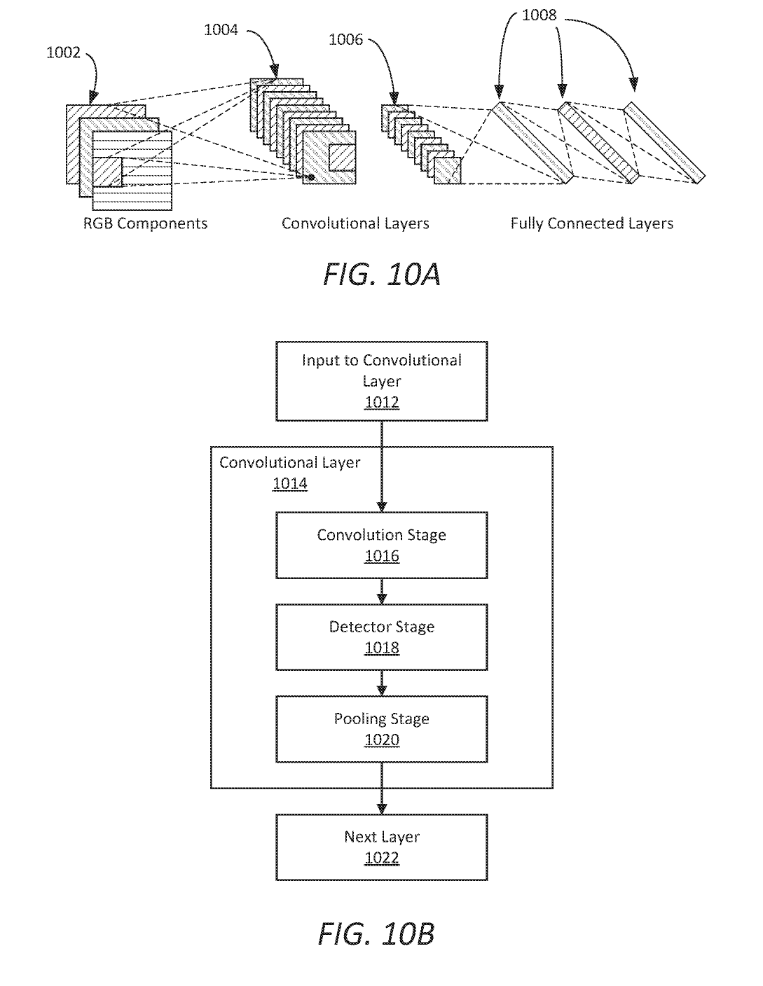

FIGS. 10A-10B illustrate an exemplary convolutional neural network. FIG. 10A illustrates various layers within a CNN. As shown in FIG. 10A, an exemplary CNN used to model image processing can receive input 1002 describing the red, green, and blue (RGB) components of an input image. The input 1002 can be processed by multiple convolutional layers (e.g., first convolutional layer 1004, second convolutional layer 1006). The output from the multiple convolutional layers may optionally be processed by a set of fully connected layers 1008. Neurons in a fully connected layer have full connections to all activations in the previous layer, as previously described for a feedforward network. The output from the fully connected layers 1008 can be used to generate an output result from the network. The activations within the fully connected layers 1008 can be computed using matrix multiplication instead of convolution. Not all CNN implementations are make use of fully connected layers 1008. For example, in some implementations the second convolutional layer 1006 can generate output for the CNN.

The convolutional layers are sparsely connected, which differs from traditional neural network configuration found in the fully connected layers 1008. Traditional neural network layers are fully connected, such that every output unit interacts with every input unit. However, the convolutional layers are sparsely connected because the output of the convolution of a field is input (instead of the respective state value of each of the nodes in the field) to the nodes of the subsequent layer, as illustrated. The kernels associated with the convolutional layers perform convolution operations, the output of which is sent to the next layer. The dimensionality reduction performed within the convolutional layers is one aspect that enables the CNN to scale to process large images.

FIG. 10B illustrates exemplary computation stages within a convolutional layer of a CNN. Input to a convolutional layer 1012 of a CNN can be processed in three stages of a convolutional layer 1014. The three stages can include a convolution stage 1016, a detector stage 1018, and a pooling stage 1020. The convolution layer 1014 can then output data to a successive convolutional layer. The final convolutional layer of the network can generate output feature map data or provide input to a fully connected layer, for example, to generate a classification value for the input to the CNN.

In the convolution stage 1016 performs several convolutions in parallel to produce a set of linear activations. The convolution stage 1016 can include an affine transformation, which is any transformation that can be specified as a linear transformation plus a translation. Affine transformations include rotations, translations, scaling, and combinations of these transformations. The convolution stage computes the output of functions (e.g., neurons) that are connected to specific regions in the input, which can be determined as the local region associated with the neuron. The neurons compute a dot product between the weights of the neurons and the region in the local input to which the neurons are connected. The output from the convolution stage 1016 defines a set of linear activations that are processed by successive stages of the convolutional layer 1014.

The linear activations can be processed by a detector stage 1018. In the detector stage 1018, each linear activation is processed by a non-linear activation function. The non-linear activation function increases the nonlinear properties of the overall network without affecting the receptive fields of the convolution layer. Several types of non-linear activation functions may be used. One particular type is the rectified linear unit (ReLU), which uses an activation function defined as ƒ(x)=max(0, x), such that the activation is thresholded at zero.

The pooling stage 1020 uses a pooling function that replaces the output of the second convolutional layer 1006 with a summary statistic of the nearby outputs. The pooling function can be used to introduce translation invariance into the neural network, such that small translations to the input do not change the pooled outputs. Invariance to local translation can be useful in scenarios where the presence of a feature in the input data is more important than the precise location of the feature. Various types of pooling functions can be used during the pooling stage 1020, including max pooling, average pooling, and 12-norm pooling. Additionally, some CNN implementations do not include a pooling stage. Instead, such implementations substitute and additional convolution stage having an increased stride relative to previous convolution stages.

The output from the convolutional layer 1014 can then be processed by the next layer 1022. The next layer 1022 can be an additional convolutional layer or one of the fully connected layers 1008. For example, the first convolutional layer 1004 of FIG. 10A can output to the second convolutional layer 1006, while the second convolutional layer can output to a first layer of the fully connected layers 1008.

The following clauses and/or examples pertain to further embodiments or examples. Specifics in the examples may be applied anywhere in one or more embodiments. The various features of the different embodiments or examples may be variously combined with certain features included and others excluded to suit a variety of different applications. Examples may include subject matter such as a method, means for performing acts of the method, at least one machine-readable medium, such as a non-transitory machine-readable medium, including instructions that, when performed by a machine, cause the machine to perform acts of the method, or of an apparatus or system for facilitating operations according to embodiments and examples described herein.

In some embodiments, one or more non-transitory computer-readable storage mediums having stored thereon executable computer program instructions that, when executed by one or more processors, cause the one or more processors to perform operations including evaluating contribution of lower level features to higher level features in a neural network, the neural network having a plurality of layers including an input layer, at least one lower level, at least one higher level, and an output layer, the evaluation including one or more of: identification of links between lower level and higher level features of the neural network; and quantification of contribution of lower level features to higher level features of the neural network; and adjusting weight associated the at least one higher level of the neural network based on the evaluation of the contribution.

In some embodiments, identification of links between lower level and higher level features of the neural network includes examining layers of the neural network from the output layer towards the input layer to identify one or more features in lower level layers of the neural network that influence one or more features in higher level layers of the neural network, wherein influence means that a value of a feature in the lower level layers has an effect on a value of a feature in the higher level layer.

In some embodiments, the one or more mediums further include instructions for determining a relative level of influence for each lower level feature having an influence on a higher level feature of the neural network.

In some embodiments, the one or more mediums further include instructions for training the neural network to include capabilities for identification of lower level features that have influence on higher level features.

In some embodiments, the quantification of contribution of lower level features to higher level features of the neural network includes performance of Principal Components Analysis (PCA) to identify a weight for each of a plurality of combinations of lower level features that contribute to a higher level feature.

In some embodiments, the one or more mediums further include instructions for one or more of training the neural network to include one or more nodes to produce values related to generating an output by the neural network; and training the neural network to include one or more nodes to produce values related to causing an output by the neural network to change to a substantially different value.

In some embodiments, one or more non-transitory computer-readable storage mediums having stored thereon executable computer program instructions that, when executed by one or more processors, cause the one or more processors to perform operations including determining support from one or more features associated with a plurality of layers of a neural network for one or more inference decisions by the neural network; determining a strength of support for each of the one or more inference decisions; identifying one or more inference decisions with low stability based at least in part on the determined strength of support for the one or more inference decisions; and reevaluating the one or more inference decisions that are identified as having low stability.

In some embodiments, determining support includes performing an assessment that includes removal of the one or more features to determine support for the one more inference decisions.

In some embodiments, the determination of the strength of support for each of the one or more inference decisions is based at least in part on a number of factors upon which each inference decision is supported.

In some embodiments, a first inference decision supported by a first number of factors is determined to be more stable than a second inference decision supported by a second number of factors, the second number of factors being less than the first number of factors.

In some embodiments, reevaluating the one or more inference decisions that are identified as having low stability includes re-performing the inference for the one or more inference decisions,

In some embodiments, one or more non-transitory computer-readable storage mediums having stored thereon executable computer program instructions that, when executed by one or more processors, cause the one or more processors to perform operations including re-performing the inference for the one or more inference decisions including adding perturbations to the input data and sampling weights of neurons from statistical distributions.

In some embodiments, one or more non-transitory computer-readable storage mediums having stored thereon executable computer program instructions that, when executed by one or more processors, cause the one or more processors to perform operations including re-performing the inference with a more compute intensive model of the neural network.

In some embodiments, a method includes evaluating contribution of lower level features to higher level features in a neural network, the neural network having a plurality of neural network layers including an input layer, at least one lower level, at least one higher level, and an output layer, the evaluation including one or more of identification of links between lower level and higher level features of the neural network; and quantification of contribution of lower level features to higher level features of the neural network; and adjusting weight associated the at least one higher level of the neural network based on the evaluation of the contribution.

In some embodiments, identification of links between lower level and higher level features of the neural network includes examining layers of the neural network from the output layer towards the input layer to identify one or more features in lower level layers of the neural network that influence one or more features in higher level layers of the neural network, wherein influence means that a value of a feature in the lower level layers has an effect on a value of a feature in the higher level layer.

In some embodiments, the method further includes determining a relative level of influence for each lower level feature having an influence on a higher level feature of the neural network.

In some embodiments, the method further includes training the neural network to include capabilities for identification of lower level features that have influence on higher level features.

In some embodiments, the quantification of contribution of lower level features to higher level features of the neural network includes performance of Principal Components Analysis (PCA) to identify a weight for each of a plurality of combinations of lower level features that contribute to a higher level feature.

In some embodiments, the method further includes one or more of training the neural network to include one or more nodes to produce values related to generating an output by the neural network; and training the neural network to include one or more nodes to produce values related to causing an output by the neural network to change to a substantially different value.

In some embodiments, a system includes one or more processors to process data; and a memory to store data, including data for neural network analysis, wherein the system is to determine support from one or more features associated with a plurality of layers of a neural network for one or more inference decisions by the neural network; determine a strength of support for each of the one or more inference decisions; identify one or more inference decisions that have low stability based at least in part on the determined strength of support for the one or more inference decisions; and reevaluate the one or more inference decisions that are identified as having low stability.

In some embodiments, determining support includes performing an assessment that includes removal of the one or more features to determine support for the one more inference decisions.

In some embodiments, the determination of the strength of support for each of the one or more inference decisions is based at least in part on a number of factors upon which each inference decision is supported.

In some embodiments, reevaluating the one or more inference decisions that are identified as having low stability includes the system to re-perform the inference for the one or more inference decisions,

In some embodiments, re-performing the inference for the one or more inference decisions includes adding perturbations to the input data and sampling weights of neurons from statistical distributions.

In some embodiments, re-performing the inference includes performing the inference with a more compute intensive model of the neural network.

In the description above, for the purposes of explanation, numerous specific details are set forth in order to provide a thorough understanding of the described embodiments. It will be apparent, however, to one skilled in the art that embodiments may be practiced without some of these specific details. In other instances, well-known structures and devices are shown in block diagram form. There may be intermediate structure between illustrated components. The components described or illustrated herein may have additional inputs or outputs that are not illustrated or described.

Various embodiments may include various processes. These processes may be performed by hardware components or may be embodied in computer program or machine-executable instructions, which may be used to cause a general-purpose or special-purpose processor or logic circuits programmed with the instructions to perform the processes. Alternatively, the processes may be performed by a combination of hardware and software.

Portions of various embodiments may be provided as a computer program product, which may include a computer-readable medium having stored thereon computer program instructions, which may be used to program a computer (or other electronic devices) for execution by one or more processors to perform a process according to certain embodiments. The computer-readable medium may include, but is not limited to, magnetic disks, optical disks, read-only memory (ROM), random access memory (RAM), erasable programmable read-only memory (EPROM), electrically-erasable programmable read-only memory (EEPROM), magnetic or optical cards, flash memory, or other type of computer-readable medium suitable for storing electronic instructions. Moreover, embodiments may also be downloaded as a computer program product, wherein the program may be transferred from a remote computer to a requesting computer. In some embodiments, a non-transitory computer-readable storage medium has stored thereon data representing sequences of instructions that, when executed by a processor, cause the processor to perform certain operations.

Many of the methods are described in their most basic form, but processes can be added to or deleted from any of the methods and information can be added or subtracted from any of the described messages without departing from the basic scope of the present embodiments. It will be apparent to those skilled in the art that many further modifications and adaptations can be made. The particular embodiments are not provided to limit the concept but to illustrate it. The scope of the embodiments is not to be determined by the specific examples provided above but only by the claims below.

If it is said that an element “A” is coupled to or with element “B,” element A may be directly coupled to element B or be indirectly coupled through, for example, element C. When the specification or claims state that a component, feature, structure, process, or characteristic A “causes” a component, feature, structure, process, or characteristic B, it means that “A” is at least a partial cause of “B” but that there may also be at least one other component, feature, structure, process, or characteristic that assists in causing “B.” If the specification indicates that a component, feature, structure, process, or characteristic “may”, “might”, or “could” be included, that particular component, feature, structure, process, or characteristic is not required to be included. If the specification or claim refers to “a” or “an” element, this does not mean there is only one of the described elements.

An embodiment is an implementation or example. Reference in the specification to “an embodiment,” “one embodiment,” “some embodiments,” or “other embodiments” means that a particular feature, structure, or characteristic described in connection with the embodiments is included in at least some embodiments, but not necessarily all embodiments. The various appearances of “an embodiment,” “one embodiment,” or “some embodiments” are not necessarily all referring to the same embodiments. It should be appreciated that in the foregoing description of exemplary embodiments, various features are sometimes grouped together in a single embodiment, figure, or description thereof for the purpose of streamlining the disclosure and aiding in the understanding of one or more of the various novel aspects. This method of disclosure, however, is not to be interpreted as reflecting an intention that the claimed embodiments requires more features than are expressly recited in each claim. Rather, as the following claims reflect, novel aspects lie in less than all features of a single foregoing disclosed embodiment. Thus, the claims are hereby expressly incorporated into this description, with each claim standing on its own as a separate embodiment.

What is claimed is:

1. One or more non-transitory computer-readable storage mediums having stored thereon executable computer program instructions that, when executed by one or more processors, cause the one or more processors to perform operations comprising:
evaluating contribution of lower level features to higher level features in a neural network, the neural network having a plurality of neural network layers including an input layer, at least one lower level, at least one higher level, and an output layer, the evaluation including one or more of:
identification of links between lower level and higher level features of the neural network, and
quantification of contribution of lower level features to higher level features of the neural network; and
adjusting weight associated with the at least one higher level of the neural network based on the evaluation of the contribution.

2. The one or more mediums of claim 1, wherein identification of links between lower level and higher level features of the neural network includes examining layers of the neural network from the output layer towards the input layer to identify one or more features in lower level layers of the neural network that influence one or more features in higher level layers of the neural network, wherein influence means that a value of a feature in the lower level layers has an effect on a value of a feature in the higher level layers.

3. The one or more mediums of claim 2, further comprising executable computer program instructions that, when executed by the one or more processors, cause the one or more processors to perform operations comprising:
determining a relative level of influence for each lower level feature having an influence on a higher level feature of the neural network.

4. The one or more mediums of claim 2, further comprising executable computer program instructions that, when executed by the one or more processors, cause the one or more processors to perform operations comprising:
training the neural network to include capabilities for identification of lower level features that have influence on higher level features.

5. The one or more mediums of claim 1, wherein the quantification of contribution of lower level features to higher level features of the neural network includes performance of Principal Components Analysis (PCA) to identify a weight for each of a plurality of combinations of lower level features that contribute to a higher level feature.

6. The one or more mediums of claim 5, further comprising executable computer program instructions that, when executed by the one or more processors, cause the one or more processors to perform operations comprising one or more of:
training the neural network to include one or more nodes to produce values related to generating an output by the neural network; and
training the neural network to include one or more nodes to produce values related to causing an output by the neural network to change to a substantially different value.

7. One or more non-transitory computer-readable storage mediums having stored thereon executable computer program instructions that, when executed by one or more processors, cause the one or more processors to perform operations comprising:
determining support from one or more features associated with a plurality of layers of a neural network for one or more inference decisions by the neural network;
determining a strength of support for each of the one or more inference decisions;
identifying one or more inference decisions with low stability based at least in part on the determined strength of support for the one or more inference decisions; and
reevaluating the one or more inference decisions that are identified as having low stability.

8. The one or more mediums of claim 7, wherein the determination of the strength of support for each of the one or more inference decisions is based at least in part on a number of factors upon which each inference decision is supported.

9. The one or more mediums of claim 8, wherein a first inference decision supported by a first number of factors is determined to be more stable than a second inference decision supported by a second number of factors, the second number of factors being less than the first number of factors.

10. The one or more mediums of claim 7, wherein reevaluating the one or more inference decisions that are identified as having low stability includes re-performing the inference for the one or more inference decisions.

11. The one or more mediums of claim 10, further comprising executable computer program instructions that, when executed by the one or more processors, cause the one or more processors to perform operations comprising:
re-performing the inference for the one or more inference decisions including adding perturbations to input data and sampling weights of neurons from statistical distributions.

12. The one or more mediums of claim 10, further comprising executable computer program instructions that, when executed by the one or more processors, cause the one or more processors to perform operations comprising:
re-performing the inference with a more compute intensive model of the neural network.

13. A method comprising:
evaluating of contribution of lower level features to higher level features in a neural network, the neural network having a plurality of neural network layers including an input layer, at least one lower level, at least one higher level, and an output layer, the evaluation including one or more of:
identification of links between lower level and higher level features of the neural network, and
quantification of contribution of lower level features to higher level features of the neural network; and
adjusting weight associated with the at least one higher level of the neural network based on the evaluation of the contribution.

14. The method of claim 13, wherein identification of links between lower level and higher level features of the neural network includes examining layers of the neural network from the output layer towards the input layer to identify one or more features in lower level layers of the neural network that influence one or more features in higher level layers of the neural network, wherein influence means that a value of a feature in the lower level layers has an effect on a value of a feature in the higher level layer.

15. The method of claim 14, further comprising:
determining a relative level of influence for each lower level feature having an influence on a higher level feature of the neural network.

16. The method of claim 14, further comprising:
training the neural network to include capabilities for identification of lower level features that have influence on higher level features.

17. The method of claim 13, wherein the quantification of contribution of lower level features to higher level features of the neural network includes performance of Principal Components Analysis (PCA) to identify a weight for each of a plurality of combinations of lower level features that contribute to a higher level feature.

18. The method of claim 17, further comprising one or more of:
training the neural network to include one or more nodes to produce values related to generating an output by the neural network; and
training the neural network to include one or more nodes to produce values related to causing an output by the neural network to change to a substantially different value.

19. A system comprising:
one or more processors to process data; and
a memory to store data, including data for neural network analysis;
wherein the system is to:
determine support from one or more features associated with a plurality of layers of a neural network for one or more inference decisions by the neural network;
determine a strength of support for each of the one or more inference decisions;
identify one or more inference decisions that have low stability based at least in part on the determined strength of support for the one or more inference decisions; and
reevaluate the one or more inference decisions that are identified as having low stability.

20. The system of claim 19, wherein the determination of the strength of support for each of the one or more inference decisions is based at least in part on a number of factors upon which each inference decision is supported.

21. The system of claim 19, wherein reevaluating the one or more inference decisions that are identified as having low stability includes the system to re-perform the inference for the one or more inference decisions.

22. The system of claim 21, wherein re-performing the inference for the one or more inference decisions includes adding perturbations to input data and sampling weights of neurons from statistical distributions.

23. The system of claim 21, wherein re-performing the inference includes performing the inference with a more compute intensive model of the neural network.
